(19) United States
(12) Patent Application Publication
(10) Pub. No.: US 2023/0052135 A1
(43) Pub. Date: Feb. 16, 2023

(54) TWO-STAGE GAS COMPRESSING APPARATUS WITH COMPRESSED-GAS PRESSURE-DIFFERENCE-USE OPTIMIZING COOLING UNIT TO PERFORM COOLING USING PRESSURE DIFFERENCE

(71) Applicant: TURBOWIN CO., LTD., Cheongju-si (KR)

(72) Inventor: Minsoo KIM, Daejeon (KR)

(73) Assignee: TURBOWIN CO., LTD., Cheongju-si (KR)

(21) Appl. No.: 17/459,709

(22) Filed: Aug. 27, 2021

(30) Foreign Application Priority Data
Aug. 16, 2021 (KR) 10-2021-0107753

(51) Int. Cl. F04D 29/58; F04D 17/12

(52) U.S. Cl. CPC F04D 29/584; F04D 17/122

(57) ABSTRACT

Disclosed is a two-stage gas compressing apparatus with a compressed-gas pressure-difference-use optimizing cooling unit to perform cooling using a pressure difference, and more specifically, to a two-stage gas compressing apparatus with a compressed-gas pressure-difference-use optimizing cooling unit to perform cooling using a pressure difference, the compressed-gas pressure-difference-use optimizing cooling unit cooling an inside of the two-stage gas compressing apparatus, collecting a gas used in cooling, re-compressing collected gas, and supplying a compressed gas to a portion which uses the compressed gas by using the pressure difference between gases generated in the completely airtight two-stage gas compressing apparatus so as to promote maximization of energy efficiency and a virtuous circle of energy.

### BACKGROUND OF THE INVENTION

### Field of the Invention

The present invention relates to a two-stage gas compressing apparatus with a compressed-gas pressure-difference-use optimizing cooling unit to perform cooling using a pressure difference, and more specifically, to a two-stage gas compressing apparatus with a compressed-gas pressure-difference-use optimizing cooling unit to perform cooling using a pressure difference, the compressed-gas pressure-difference-use optimizing cooling unit cooling an inside of the two-stage gas compressing apparatus, collecting a gas used in cooling, re-compressing collected gas, and supplying a compressed gas to a portion which uses the compressed gas by using the pressure difference between gases generated in the completely airtight two-stage gas compressing apparatus so as to promote maximization of energy efficiency and a virtuous circle of energy.

### Description of the Related Art

A gas compression means is a machine that increases the pressure of gas or air, and is a mechanical device used as a pressure source of an air driving device or in driving a compressing air device or a rock drill etc. by blowing out a gas having a high density with respect to the resistance of the connecting device.

That is, it is a device for compressing gas by rotational driving of an impeller and is a mechanical device for supplying the compressed gas to a necessary place.

In case of such a gas compression means, since the impeller must be rotated at a high speed, the cooling of the driving element for rotating the impeller is important.

The cooling is directly related to durability and lifespan along with the performance of mechanical devices.

Accordingly, various cooling systems and cooling methods are applied to the gas compression means.

However, the present invention is to provide a two-stage gas compression apparatus for cooling using a pressure difference inside the gas compression means and cooling using a pressure difference between gases generated therein by applying to low-temperature and low-horsepower gas compression means by itself, without a separate cooling device and cooling system.

In the meantime, as a prior art related to a two-stage gas compressing apparatus with a compressed-gas pressure-difference-use optimizing cooling unit to perform cooling using a pressure difference, “SYSTEM AND METHOD FOR COOLING A COMPRESSOR MOTOR” of Korean Patent Registration No. 10-1103245 (hereinafter referred to as “Patent Literature 1”) is disclosed as shown in FIG. 7A.

Patent Literature 1 relates to a gas compression system having a compressor with a compressing mechanism comprising an impeller, a motor connected to the compressor to drive the compressing mechanism, a housing enclosing the compressor and the motor, and a suction assembly for receiving uncompressed gas from a gas source and conveying the uncompressed gas to the compressor, the suction assembly comprising: a suction pipe in fluid communication with the gas source; means for creating a pressure reduction in the uncompressed gas from the gas source; the means for creating a pressure reduction being in fluid communication with the suction pipe; the means for creating a pressure reduction being a converging nozzle receiving uncompressed gas from the suction pipe, and providing the uncompressed gas to a compressor inlet, an annular wall of the converging nozzle having a converging portion accelerating flow of uncompressed gas to the compressor inlet; an annular gap, extending around the converging nozzle, spacing the converging nozzle from the impeller wherein, the housing comprises an inlet opening in fluid communication with the gas source, the converging nozzle drawing uncompressed gas from the gas source through the housing to cool the motor and returning the uncompressed gas to the compressor inlet through at least one aperture and the at least one aperture providing fluid communication from the outlet opening in the housing to the impeller of the compressor through the annular wall of the converging nozzle. Accordingly, the cooling of hermetic and semi-hermetic motors is accomplished by a gas sweep using a gas source located in the low-pressure side of a gas compression circuit. The gas sweep is provided by the creation of a pressure reduction at the compressor inlet sufficient to draw uncompressed gas through a motor housing, across the motor, and out of the housing for return to the suction assembly. The pressure reduction is created by means provided in the suction assembly, such as a nozzle and gap assembly, or alternatively a venturi, located upstream of the compressor inlet. Additional motor cooling can be provided by circulating liquid or another cooling fluid through a cooling jacket in the motor housing portion adjacent the motor.

As another prior art, “COOLING CYCLE DEVICE FOR MULTI-STAGE COMPRESSOR” of Korean Patent Registration No. 10-1052513 (hereinafter referred to as “Patent Literature 2”) is disclosed as shown in FIG. 7B.

Patent Literature 2 relates to a cooling cycle device for a multi-stage compressor is provided to reduce the installing and operating cost and to achieve the efficient heat management by the cooling of the refrigerant through a simple circulating structure. The cooling cycle device for a compressor comprises a heating unit, a first compressor, a first intercooler, a second compressor, a second intercooler, a refrigerant circulating line, and a refrigerant supply controller. The heating unit is installed on a gas supply line and heats the super low temperature gas to become the room temperature gas. The first compressor compresses the heated gas to become the gas of the high pressure and temperature. The first intercooler drops the temperature of the compressed gas. The second compressor compresses the temperature-dropped compressed gas to become the gas of the high pressure and temperature. The second intercooler cools the compresses gas of the high temperature. The refrigerant circulating line is installed to circulate the heating unit and the first and second intercoolers to perform the heat exchange. The refrigerant supply controller is installed on the refrigerant circulating line and controls the amount of the refrigerant.

As described above, Patent Literatures 1 and 2 are the same technical field as the present invention and have similar and identical technical concepts in terms of the basic elements of the invention and the object of the invention for cooling the gas compression means in comparison with the present invention. However, there is a difference in terms of the subject matters to be solved by the invention (object of the invention).

That is, there are differences in technical characteristics in specific solutions (components) of the invention for solving the problem to be solved by the invention and exerting the effect thereof.

Accordingly, the present invention is different from the technology for the cooling system of the conventional gas compression means including the Patent Literature 1 and Patent Literature 2. Also, the present invention seeks to achieve the technical features based on the problem to be solved by the invention (object of the invention), a solution means (element) for solving it, and the effect exerted by solving the same.

### PATENT LITERATURE

Patent Literature 1: Korean Patent Registration No. 10-1103245 (Dec. 30, 2011)
Patent Literature 2: Korean Patent Registration No. 10-1052513 (Jul. 22, 2011)

### SUMMARY OF THE INVENTION

Hence, the present invention is made to solve the above-described problems in the related art, and an object thereof is to provide a two-stage gas compressing apparatus that is driven and cooled without a loss of gas other than a compressed gas which is discharged.

In other words, the object of the present invention is to provide the two-stage gas compressing apparatus of which an inside is cooled using only a pressure difference in the completely airtight inside without a separate cooling device and a cooling system.

In addition, the object of the present invention is to provide the two-stage gas compressing apparatus that enables energy efficiency to be maximized and a virtuous circle of energy to be obtained by performing cooling using a pressure difference and re-compressing a gas used in cooling together with a gas flowing therein.

According to an aspect of the invention to achieve the object described above, there is provided a two-stage gas compressing apparatus with a compressed-gas pressure-difference-use optimizing cooling unit to perform cooling using a pressure difference, the two-stage gas compressing apparatus including:

a compressed-gas cooling-type two-stage gas compressing unit that suctions and compresses a gas and supplies a compressed gas to a portion which is uses the compressed gas; and

a compressed-gas pressure-difference-use optimizing cooling unit that is formed at one side of an inside of the compressed-gas cooling-type two-stage gas compressing unit, cools the inside of the compressed-gas cooling-type two-stage gas compressing unit with a second cooling compressed gas using an internal pressure difference of the compressed-gas cooling-type two-stage gas compressing unit, and collects and re-compresses, as a third compressed gas, the second cooling compressed gas used in cooling through the compressed-gas cooling-type two-stage gas compressing unit such that a virtuous circle of energy is obtained,

wherein the inside of the compressed-gas cooling-type two-stage gas compressing unit is cooled through the compressed-gas pressure-difference-use optimizing cooling unit using a pressure difference generated in the airtight inside of the compressed-gas cooling-type two-stage gas compressing unit and the compressed gas used in cooling the inside is collected and re-compressed together with a suctioned gas such that energy efficiency and a virtuous circle of energy are both obtained.

At this time, the compressed-gas cooling-type two-stage gas compressing unit suctions a low-temperature gas and has a low-power capacity.

In addition, the compressed-gas cooling-type two-stage gas compressing unit is configured to include:

a first gas suctioning chamber in which a first gas-compression impeller is positioned, the first gas-compression impeller suctioning and primarily compressing a gas;

a second gas suctioning chamber in which a second gas-compression impeller is positioned, the second gas-compression impeller secondarily re-compressing a first compressed gas suctioned and compressed in the first gas suctioning chamber; and

a gas suctioning/compressing chamber which is formed between the first gas suctioning chamber and the second gas suctioning chamber and in which a gas-compression stator, a gas-compression rotor, and a gas-compression shaft that are driven to suction, compress, and discharge a gas are positioned,

wherein the gas suctioning chambers are completely airtight from each other, and

wherein, when ‘P1’ represents a pressure in the first gas suctioning chamber, ‘P2’ represents a pressure in the second gas suctioning chamber, and ‘P3’ represents a pressure in the gas suctioning/compressing chamber, the following inequation is satisfied.

P1<P2<P3

In the meantime, it should be understood that the terminology or the words used in claims should not be interpreted in normally or lexically sense. It should be interpreted as meaning and concept consistent with the technical idea of the present invention, based on the principle that the inventor can properly define the concept of the term in order to describe its invention in the best way.

Therefore, the embodiments described in the present specification and the configurations shown in the drawings are only the most preferred embodiments of the present invention, and not all the technical ideas of the present invention are described. Therefore, it is to be understood that various equivalents and modifications are possible.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating a configuration of a two-stage gas compressing apparatus with a compressed-gas pressure-difference-use optimizing cooling unit to perform cooling using a pressure difference according to the invention;

FIG. 2 is a conceptual diagram illustrating the two-stage gas compressing apparatus with a compressed-gas pressure-difference-use optimizing cooling unit to perform cooling using a pressure difference according to the invention;

FIG. 3 is a cross-sectional view of an embodiment of the two-stage gas compressing apparatus with a compressed-gas pressure-difference-use optimizing cooling unit to perform cooling using a pressure difference according to the invention;

FIG. 4 schematically illustrates a route of a compressed gas through the compressed-gas pressure-difference-use optimizing cooling unit by using the cross-sectional view of the embodiment of the two-stage gas compressing apparatus with a compressed-gas pressure-difference-use optimizing cooling unit to perform cooling using a pressure difference according to the invention;

FIG. 5 is a cross-sectional view of another embodiment of the two-stage gas compressing apparatus with a compressed-gas pressure-difference-use optimizing cooling unit to perform cooling using a pressure difference according to the invention;

FIG. 6 is a flowchart schematically illustrating an overall mechanism of the two-stage gas compressing apparatus with a compressed-gas pressure-difference-use optimizing cooling unit to perform cooling using a pressure difference according to the invention; and

FIG. 7A is a representative view of the Patent Literature 1 for the two-stage gas compressing apparatus with a compressed-gas pressure-difference-use optimizing cooling unit to perform cooling using a pressure difference according to the invention; and

FIG. 7B is a representative view of the Patent Literature 2 for the two-stage gas compressing apparatus with a compressed-gas pressure-difference-use optimizing cooling unit to perform cooling using a pressure difference according to the invention.

### REFERENCE SIGNS LIST

1: two-stage gas compressing apparatus with compressed-gas pressure-difference-use optimizing cooling unit to perform cooling using pressure difference
100: compressed-gas cooling-type two-stage gas compressing unit
110: gas-compression housing
111: first gas suctioning chamber
112: second gas suctioning chamber
113: gas suctioning/compressing chamber
120: gas-compression stator
130: gas-compression rotor
140: gas-compression shaft
150: first gas-compression impeller
160: second gas-compression impeller
170: two-stage gas-compression passage
200: compressed-gas pressure-difference-use optimizing cooling unit
210: two-stage compressed-gas inflow module for cooling
211: two-stage compressed-gas using cooling-hole group
220: post-cooling two-stage compressed-gas emitting module
221: post-cooling compressed-gas collecting circulation-hole group
230: pressure-difference-based compressed-gas cooling path module
231: pressure-difference-based compressed-gas cooling path element
232: pressure-difference-based compressed-gas emitting path element
240: zero-gas-loss virtuous circle path module
241: pressure-difference-based compressed-gas circulating path element
D1: diameter of two-stage compressed-gas using cooling-hole group (211)
D2: diameter of post-cooling compressed-gas collecting circulation-hole group
G1: first compressed gas (compressed gas compressed in first gas suctioning chamber (111))
G2: second compressed gas
G2′: second cooling compressed gas (a part of the second compressed gas (G2) flowing into gas suctioning/compressing chamber (113))
G3: third compressed gas (second cooling compressed gas (G2′) flowing into first gas suctioning chamber (111))
P1: pressure in first gas suctioning chamber (111)
P2: pressure in second gas suctioning chamber (112)
P3: pressure in gas suctioning/compressing chamber (113)

### DETAILED DESCRIPTION OF THE PREFERRED EMBODIMENT

Hereinafter, functions, configurations, and effects of a two-stage gas compressing apparatus (1) with a compressed-gas pressure-difference-use optimizing cooling unit to perform cooling using a pressure difference according to the invention will be described in detail with reference to the accompanying drawings.

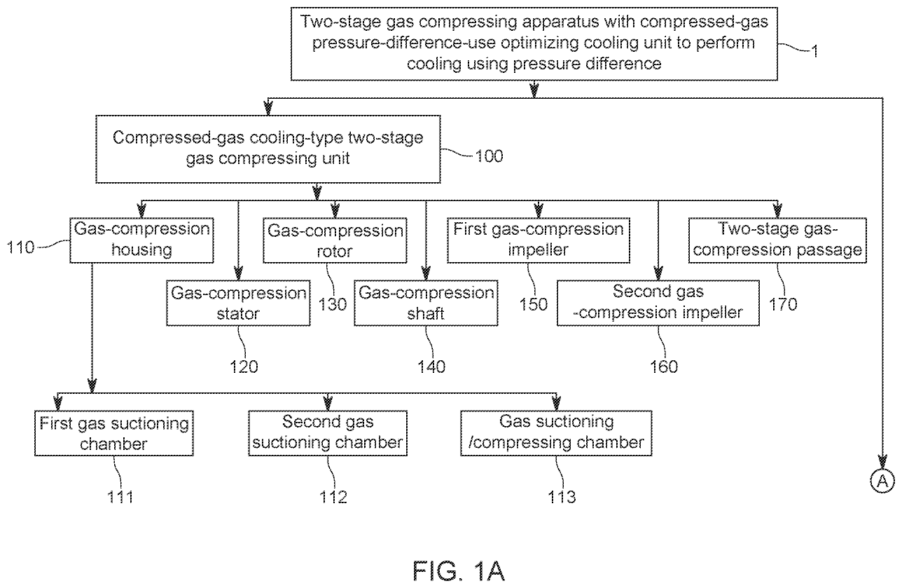

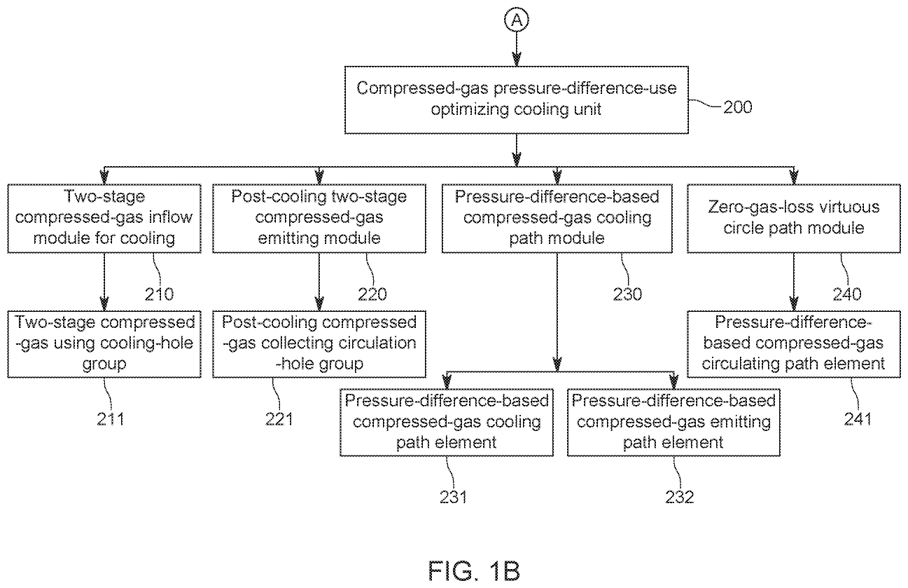

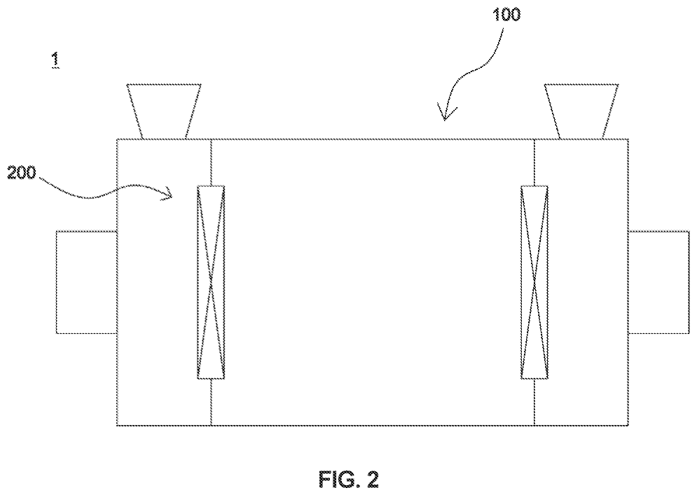

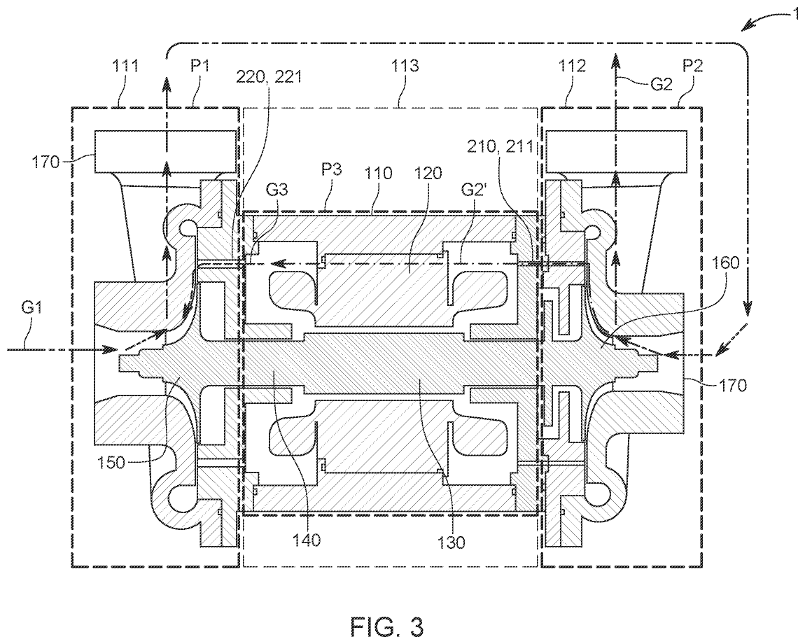

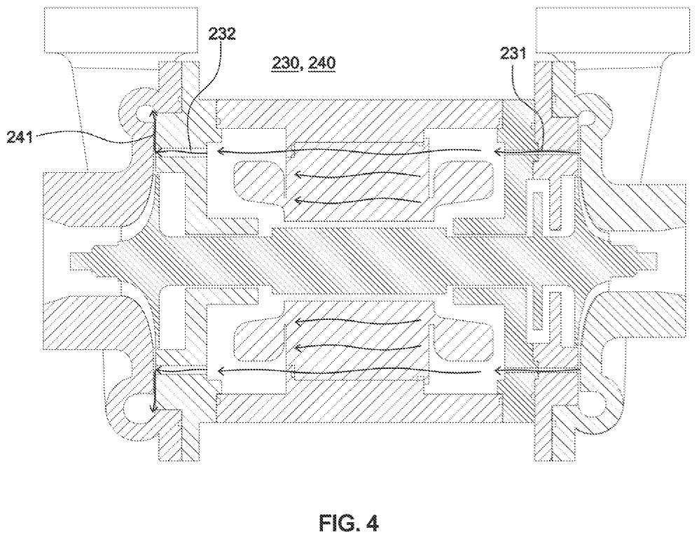

FIG. 1 is a diagram illustrating a configuration of a two-stage gas compressing apparatus with a compressed-gas pressure-difference-use optimizing cooling unit to perform cooling using a pressure difference according to the invention. FIG. 2 is a conceptual diagram illustrating the two-stage gas compressing apparatus with a compressed-gas pressure-difference-use optimizing cooling unit to perform cooling using a pressure difference according to the invention. FIG. 3 is a cross-sectional view of an embodiment of the two-stage gas compressing apparatus with a compressed-gas pressure-difference-use optimizing cooling unit to perform cooling using a pressure difference according to the invention. FIG. 4 schematically illustrates a route of a compressed gas through the compressed-gas pressure-difference-use optimizing cooling unit by using the cross-sectional view of the embodiment of the two-stage gas compressing apparatus with a compressed-gas pressure-difference-use optimizing cooling unit to perform cooling using a pressure difference according to the invention.

According to the invention, as illustrated in FIGS. 1 to 4, the two-stage gas compressing apparatus (1) with a compressed-gas pressure-difference-use optimizing cooling unit to perform cooling using a pressure difference includes: a compressed-gas cooling-type two-stage gas compressing unit (100) that suctions and compresses a gas and supplies a compressed gas to a portion which uses the compressed gas; and a compressed-gas pressure-difference-use optimizing cooling unit (200) that is formed at one side of an inside of the compressed-gas cooling-type two-stage gas compressing unit (100), cools the inside of the compressed-gas cooling-type two-stage gas compressing unit (100) with a second cooling compressed gas (G2′) using an internal pressure difference of the compressed-gas cooling-type two-stage gas compressing unit (100), and collects and re-compresses, as a third compressed gas (G3), the second cooling compressed gas (G2′) used in cooling through the compressed-gas cooling-type two-stage gas compressing unit (100) such that a virtuous circle of energy is obtained. The inside of the compressed-gas cooling-type two-stage gas compressing unit (100) is cooled through the compressed-gas pressure-difference-use optimizing cooling unit (200) using a pressure difference generated in the airtight inside of the compressed-gas cooling-type two-stage gas compressing unit (100) and the compressed gas used in cooling the inside is collected and re-compressed together with a suctioned gas such that energy efficiency and a virtuous circle of energy are both obtained.

In other words, the invention is a technology of a gas compressing apparatus that performs cooling using the internal pressure difference inside the compressed-gas cooling-type two-stage gas compressing unit (100), in which the inside of the compressed-gas cooling-type two-stage gas compressing unit (100) is cooled along a specific flow path generated by the compressed-gas pressure-difference-use optimizing cooling unit (200) using the pressure difference generated inside the compressed-gas cooling-type two-stage gas compressing unit (100), and the compressed gas which cools the inside of the compressed-gas cooling-type two-stage gas compressing unit (100) along the specific flow path, that is, the third compressed gas (G3), is collected and re-suctioned and re-compressed through the compressed-gas cooling-type two-stage gas compressing unit (100), and thereby the inside of the compressed-gas cooling-type two-stage gas compressing unit (100) is cooled and the compressed gas used in cooling the inside is collected to flow back into the compressed-gas cooling-type two-stage gas compressing unit (100) without a separate device for cooling the inside of the compressed-gas cooling-type two-stage gas compressing unit (100), such that energy efficiency and a virtuous circle of energy are obtained.

More specifically, the compressed-gas cooling-type two-stage gas compressing unit (100) suctions a low-temperature gas and has a low-power capacity, and the compressed-gas cooling-type two-stage gas compressing unit (100) includes: a gas-compression housing (110) that suctions a gas, guides the suctioned gas to flow and be discharged, and protects, from outside, a gas-compression stator (120), a gas-compression rotor (130), a gas-compression shaft (140), and a gas-compression impeller (150) which are positioned and coupled inside the gas-compression housing; the gas-compression stator (120) that is a stator positioned inside the gas-compression housing (110); the gas-compression 1o rotor (130) that is a rotor positioned inside the gas-compression housing (110); the gas-compression shaft (140) that is coupled to the gas-compression rotor (130) and is rotated; a first gas-compression impeller (150) that is coupled to an end portion of the gas-compression shaft (140) and is rotated driven by rotation of the gas-compression shaft (140) to suction a gas, primarily compress suctioned gas, and generate a first compressed gas (G1); a second gas-compression impeller (160) that is coupled to the other end portion of the gas-compression shaft (140) and is rotated driven by the rotation of the gas-compression shaft (140) to secondarily compress the first compressed gas (G1) primarily compressed by the first gas-compression impeller (150) and generate and discharge a second compressed gas (G2); and a two-stage gas-compression passage (170) through which the first compressed gas (G1) discharged from the first gas-compression impeller (150) is suctioned by the second gas-compression impeller (160). The gas is suctioned and the suctioned gas is primarily and secondarily compressed such that suctioning and discharging of the gas and compressed gas are to be smoothly performed so as to supply the second compressed gas (G2) to a portion which uses the second compressed gas.

In this case, the gas-compression housing (110) is configured to include: a first gas suctioning chamber (111) in which the first gas-compression impeller (150) is positioned, the first gas-compression impeller suctioning and primarily compressing a gas; a second gas suctioning chamber (112) in which the second gas-compression impeller (160) is positioned, the second gas-compression impeller secondarily re-compressing the first compressed gas (G1) suctioned and compressed in the first gas suctioning chamber (111); and a gas suctioning/compressing chamber (113) which is formed between the first gas suctioning chamber (111) and the second gas suctioning chamber (112) and in which the gas-compression stator (120), the gas-compression rotor (130), and the gas-compression shaft (140) that are driven to suction, compress, and discharge a gas are positioned. The first gas suctioning chamber (111), the second gas suctioning chamber (112), and the gas suctioning/compressing chamber (113) are formed in a completely airtight state to inhibit an energy loss and maximize efficiency except for a portion from which a gas is first suctioned and a portion from which the second compressed gas (G2) is finally discharged.

In this case, the first gas suctioning chamber (111), the second gas suctioning chamber (112), and the gas suctioning/compressing chamber (113) are completely airtight from each other. When ‘P1’ represents a pressure in the first gas suctioning chamber (111), ‘P2’ represents a pressure in the second gas suctioning chamber (112), and ‘P3’ represents a pressure in the gas suctioning/compressing chamber (113), pressures are generated to satisfy the following inequation.

P1<P2<P3

Here, a second cooling compressed gas (G2′) which is generated from the second gas suctioning chamber (112) to cool the gas suctioning/compressing chamber (113) is to flow from the second gas suctioning chamber (112) through the gas suctioning/compressing chamber (113) to the first gas suctioning chamber (111).

The compressed-gas pressure-difference-use optimizing cooling unit (200) is configured to include: a two-stage compressed-gas inflow module for cooling (210) which is formed at a location near the second gas-compression impeller (160) of the compressed-gas cooling-type two-stage gas compressing unit (100) and allows the second cooling compressed gas (G2′) as a part of the second compressed gas (G2) compressed at the second gas-compression impeller (160) to flow into the gas-compression housing (110) of the compressed-gas cooling-type two-stage gas compressing unit (100) due to a pressure difference; a post-cooling two-stage compressed-gas emitting module (220) which is formed at a location near the first gas-compression impeller (150) of the compressed-gas cooling-type two-stage gas compressing unit (100) and allows the second cooling compressed gas (G2′) that flows through the two-stage compressed-gas inflow module for cooling (210) and cools an inside of the gas-compression housing (110) of the compressed-gas cooling-type two-stage gas compressing unit (100) due to a pressure difference to be emitted as a third compressed gas (G3); a pressure-difference-based compressed-gas cooling path module (230) which is formed to emit the second cooling compressed gas (G2′) to the post-cooling two-stage compressed-gas emitting module (220) due to a pressure difference, after the second cooling compressed gas (G2′) flows through the two-stage compressed-gas inflow module for cooling (210) and cools the inside of the gas-compression housing (110); and a zero-gas-loss virtuous circle path module (240) which is formed to allow the second cooling compressed gas (G2′) emitted through the pressure-difference-based compressed-gas cooling path module (230) to flow as the third compressed gas (G3) to one side of the first gas-compression impeller (150) and be re-compressed by the first gas-compression impeller (150). The inside of the compressed-gas cooling-type two-stage gas compressing unit (100) is cooled and the compressed gas is circulated along a virtuous circle through the zero-gas-loss virtuous circle path module (240) by using the pressure difference generated in the compressed-gas cooling-type two-stage gas compressing unit (100) without a separate cooling device for cooling the inside of the compressed-gas cooling-type two-stage gas compressing unit (100), and thereby the energy efficiency and the virtuous circle of energy are obtained due to a minimum gas loss.

In this case, the two-stage compressed-gas inflow module for cooling (210) is configured of a two-stage compressed-gas using cooling-hole group (211) which is formed to have a certain diameter (D1) and pass from one side of the second gas suctioning chamber (112) to one side of the gas suctioning/compressing chamber (113) and allows the second cooling compressed gas (G2′) as a part of the second compressed gas (G2) generated in the second gas suctioning chamber (112) to flow into the gas suctioning/compressing chamber (113). The second cooling compressed gas (G2′) which is a part of the second compressed gas (G2) generated from the second gas suctioning chamber (112) is caused to flow into the gas suctioning/compressing chamber (113) due to the pressure difference to cool the gas suctioning/compressing chamber (113). The post-cooling two-stage compressed-gas emitting module (220) is configured of a post-cooling compressed-gas collecting circulation-hole group (221) which is formed to have a certain diameter (D2) and pass from one side of the gas suctioning/compressing chamber (113) to one side of the first gas suctioning chamber (111) and allows the second cooling compressed gas (G2′) located at the gas suctioning/compressing chamber (113) to flow into the first gas suctioning chamber (111). The second cooling compressed gas (G2′) that has cooled the gas suctioning/compressing chamber (113) is emitted to the first gas suctioning chamber (111) due to the pressure difference, thereby flowing between the first gas suctioning chamber (111), the second gas suctioning chamber (112), and the gas suctioning/compressing chamber (113) without a gas loss, such that the energy efficiency is maximized.

In addition, the pressure-difference-based compressed-gas cooling path module (230) using a pressure difference is configured to include: a pressure-difference-based compressed-gas cooling path element (231) which is formed as a specific path for flowing of the second cooling compressed gas (G2′) as a part of the second compressed gas (G2) through the two-stage compressed-gas using cooling-hole group (211); and a pressure-difference-based compressed-gas emitting path element (232) which is formed as a specific path for flowing of the second cooling compressed gas (G2′) as a part of the second compressed gas (G2) through the post-cooling compressed-gas collecting circulation-hole group (221). The zero-gas-loss virtuous circle path module (240) is configured of a pressure-difference-based compressed-gas circulating path element (241) which is formed as a specific path for flowing of the third compressed gas (G3) and allows the second cooling compressed gas (G2′) emitted through the post-cooling compressed-gas collecting circulation-hole group (221) to circulate as the third compressed gas (G3). The second cooling compressed gas (G2′) as a part of the second compressed gas (G2) generated from the second gas suctioning chamber (112) flows into the gas suctioning/compressing chamber (113) due to the pressure difference, cools the gas suctioning/compressing chamber (113), and then flows into the first gas suctioning chamber (111). The second cooling compressed gas (G2′) flowing into the first gas suctioning chamber (111) is re-compressed as the third compressed gas (G3) in the first gas suctioning chamber (111) such that the virtuous circle of energy is obtained without an energy loss.

In this case, when ‘D1’ represents a certain diameter of the two-stage compressed-gas using cooling-hole group (211), and ‘D2’ represents a certain diameter of the post-cooling compressed-gas collecting circulation-hole group (221), an inequation of D1<D2 is established.

Consequently, an effect on a discharge amount of the second compressed gas (G2) generated from the second gas suctioning chamber (112) is minimized, the second cooling compressed gas (G2′) as a part of the second compressed gas (G2) is allowed to flow into the gas suctioning/compressing chamber (113) due to the pressure difference, and the second cooling compressed gas (G2′) flowing into the gas suctioning/compressing chamber (113) due to the pressure difference is allowed to smoothly flow, be emitted, and be circulated to the first gas suctioning chamber (111) such that the energy efficiency is to be maximized.

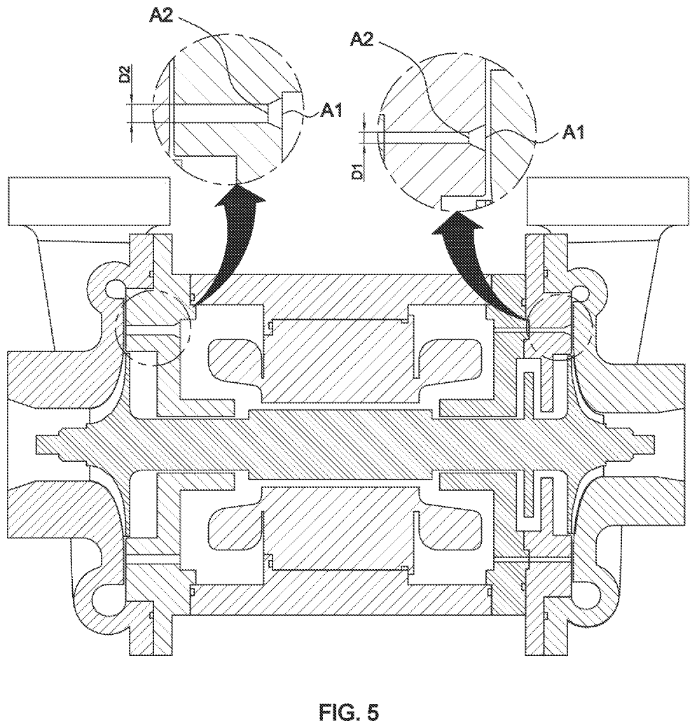

On the other hand, for example, the two-stage compressed-gas using cooling-hole group (211) has an end portion having a trapezoidal shape at a side toward which the second cooling compressed gas (G2′) flows, that is, the second gas suctioning chamber (112) side, as illustrated in FIG. 5, and thus in accordance with a correlation (Bernoulli's principle) between a first cross-sectional area (A1) and a second cross-sectional area (A2), the second cooling compressed gas (G2′) is to flow much more actively through the second cross-sectional area (A2), thereby, enabling to rapidly enter the gas suctioning/compressing chamber (113) along the specific path (pressure-difference-based compressed-gas cooling path element (231)).

In addition, similarly to the shape of the two-stage compressed-gas using cooling-hole group (211), the post-cooling compressed-gas collecting circulation-hole group (221) has a trapezoidal shape at a side toward which the second cooling compressed gas (G2′) which has cooled the gas suctioning/compressing chamber (113) flows, that is, an end side of the gas suctioning/compressing chamber (113), and thus in accordance with a correlation (Bernoulli's principle) between a first cross-sectional area (A1) and a second cross-sectional area (A2), the second cooling compressed gas (G2′) is to flow much more actively through the second cross-sectional area (A2), thereby, enabling to rapidly enter the first gas suctioning chamber (111) along the specific path (pressure-difference-based compressed-gas emitting path element 232).

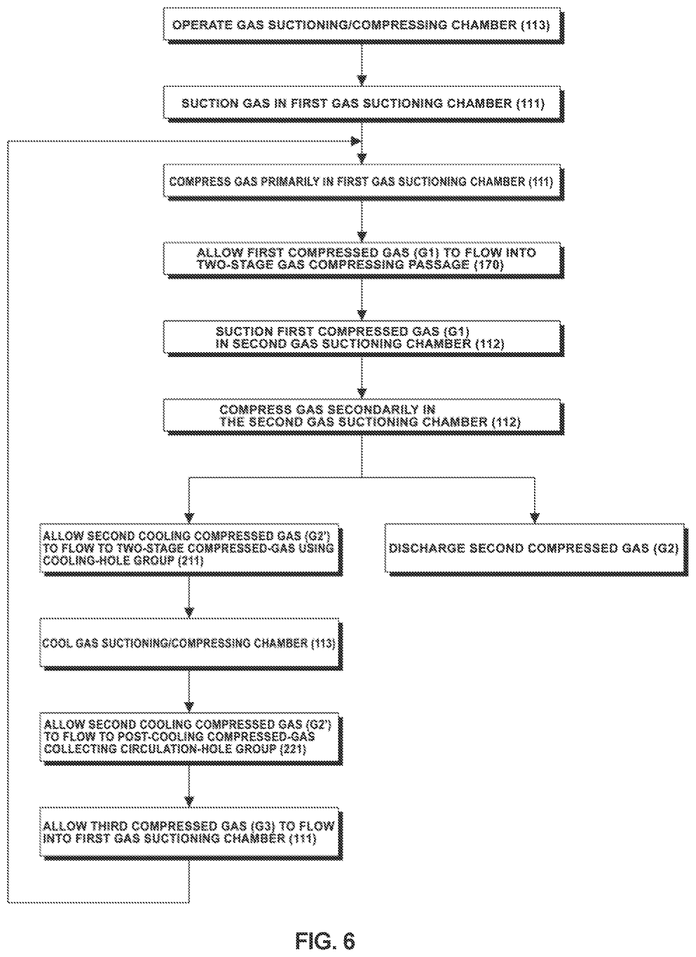

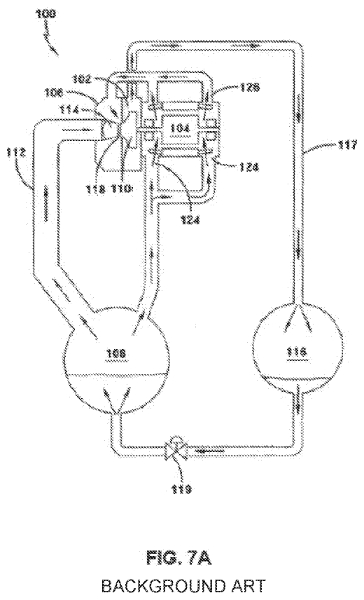

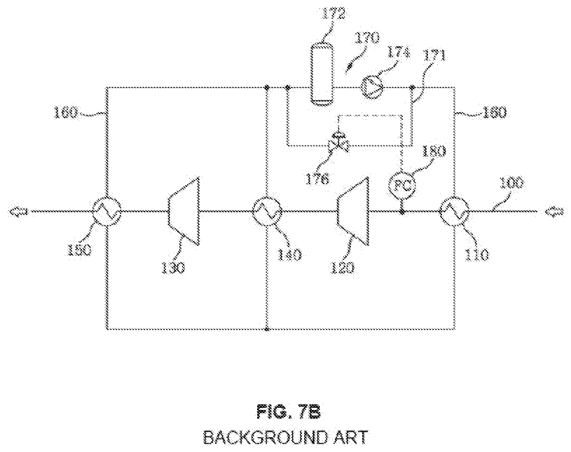

FIG. 6 is a flowchart schematically illustrating an overall mechanism of the two-stage gas compressing apparatus with a compressed-gas pressure-difference-use optimizing cooling unit to perform cooling using a pressure difference according to the invention.

As described above in the configurations and effects, according to the invention:

1. the two-stage gas compressing apparatus is driven and cooled without a loss of gas other than a compressed gas which is discharged in a process of suctioning, compressing, and discharging a gas.

2. A cooling effect is improved while a means for cooling the two-stage gas compressing apparatus is simplified such that a cost reduction effect on manufacturing and maintenance is maximized.

3. The invention is also very effective in that energy efficiency is maximized without a loss of gas, and a virtuous circle of energy is obtained not to waste gas.

It will be apparent to those skilled in the art that various modifications and variations can be made in the present invention without departing from the spirit or scope of the invention as defined in the appended claims.

This invention can be implemented in many different forms without departing from technical aspects or main features. Therefore, the implementation examples of this invention are nothing more than simple examples in all respects and will not be interpreted restrictively.

### INDUSTRIAL APPLICABILITY

The present invention relates to a two-stage gas compressing apparatus with a compressed-gas pressure-difference-use optimizing cooling unit to perform cooling using a pressure difference, it can be applied to a manufacturing and sales business of manufacturing them, and it can contribute to an improvement in general industrial sites where two-stage gas compressing apparatus is utilized and various industrial fields in which compressors are used.

1: A two-stage gas compressing apparatus to perform cooling using a pressure difference, the two-stage gas compressing apparatus comprising:
a compressed-gas cooling-type two-stage gas compressing unit that suctions and compresses a gas and supplies a first compressed gas (G1) to a portion which uses the compressed gas; and
a compressed-gas pressure-difference-use optimizing cooling unit that is formed at one side of an inside of the compressed-gas cooling-type two-stage gas compressing unit, cools the inside of the compressed-gas cooling-type two-stage gas compressing unit with a second cooling compressed gas using an internal pressure difference of the compressed-gas cooling-type two-stage gas compressing unit, and collects and re-compresses, as a third compressed gas, (G3), the second cooling compressed gas (G2′) used in cooling through the compressed-gas cooling-type two-stage gas compressing unit such that a continuous cycle of energy is obtained,
wherein the inside of the compressed-gas cooling-type two-stage gas compressing unit is cooled through the compressed-gas pressure-difference-use optimizing cooling unit using a pressure difference generated in the inside of the compressed-gas cooling-type two-stage gas compressing unit and the compressed gas used in cooling the inside of the compressed-gas cooling-type two-stage gas compressing unit is collected and re-compressed together with a suctioned gas such that energy efficiency and the continuous cycle of energy are both obtained.

2. (canceled)

3: The two-stage gas compressing apparatus to perform cooling using a pressure difference according to claim 1,
wherein the compressed-gas cooling-type two-stage gas compressing unit is configured to include:
a first gas suctioning chamber in which a first gas-compression impeller is positioned, the first gas-compression impeller suctioning and primarily compressing the first compressed gas (G1);
a second gas suctioning chamber in which a second gas-compression impeller is positioned, the second gas-compression impeller secondarily re-compressing, as a second compressed gas (G2), the first compressed gas (G1) suctioned and compressed in the first gas suctioning chamber; and
a gas suctioning/compressing chamber which is formed between the first gas suctioning chamber and the second gas suctioning chamber and in which a gas-compression stator, a gas-compression rotor, and a gas-compression shaft that are driven to suction, compress, and discharge a gas are positioned,
wherein, the inequation P1<P3<P2 is satisfied where P1 represents a pressure in the first gas suctioning chamber, P2 represents a pressure in the second gas suctioning chamber, and P3 represents a pressure in the gas suctioning/compressing chamber.

4: The two-stage gas compressing apparatus to perform cooling using a pressure difference according to claim 3, wherein the compressed-gas cooling-type two-stage gas compressing unit is configured to further include:
a two-stage gas-compression passage through which the first compressed gas discharged from the first gas-compression impeller is suctioned by the second gas-compression impeller.
